(19) United States
(12) Patent Application Publication
(10) Pub. No.: US 2004/0183920 A1
(43) Pub. Date: Sep. 23, 2004

(54) Image capturing device having a plurality of solid image capturing elements

(75) Inventor: Takashi Tanimoto, Motosu-Gun (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/765,662

(22) Filed: Jan. 27, 2004

(30) Foreign Application Priority Data
Feb. 14, 2003 (JP) 2003-36291

(51) Int. Cl. H04N 5/228

(52) U.S. Cl. 348/222.1

(57) ABSTRACT

An image capturing device comprising first and second solid image capturing elements each having a plurality of light receiving elements, a driving control circuit for controlling operation of the first and second solid image capturing elements, and a register for storing first and second setting data which respectively designate driving conditions for the first and second solid image capturing elements, wherein the driving control circuit drives the first solid image capturing element according to the first setting data and the second solid image capturing element according to the second setting data.

### BACKGROUND OF THE INVENTION

1. Field of the Invention

The present invention relates to an image capturing device for capturing a plurality of images of an object using a plurality of solid image capturing elements and combining the obtained image signals of a plurality of sequences for output.

2. Description of the Related Art

Image capturing devices, such as digital cameras, equipped with a plurality of solid image capturing elements for capturing a plurality of images of an object and combining the obtained image signals of a plurality of sequences for display on a common display screen are suggested (Japanese Patent Laid-open Application No. Sho 64-62974).

Such an image capturing device may have a structure as shown in FIG. 4, for example. Specifically, the device comprises, for a first image capturing sequence, a first solid image capturing element 1a, a first driving circuit 2a, and a first signal processing circuit 4a and, for a second image capturing sequence, a second solid image capturing element 1b, a second driving circuit 2b, and a second signal processing circuit 4b. The device further comprises common circuits including a synchronism signal generation circuit 3, a selection circuit 5, and a signal processing circuit 6.

In the image capturing device shown in FIG. 4, the first and second driving circuits 2a, 2b drive the first and second image capturing elements 1a, 1b, respectively, in response to a timing signal from the synchronism signal generation circuit 3, and image signals of two sequences from the first and second solid image capturing elements 1a, 1b are supplied to the first and second signal processing circuits 4a, 4b, respectively. The first and second signal processing circuits 4a, 4b apply gamma correction and/or AGC (Automatic Gain Control) to an image signal of each sequence before outputting to the selection circuit 5. The selection circuit 5 receives the image signals of two sequences via its respective input terminals to alternately select one image signal out of the received image signals of two sequences, and outputs the selected image signal to the third signal processing circuit 6. The third signal processing circuit 6 applies color separation, matrix operation, and so forth to the image signal selected by the selection circuit 5 to thereby generate an image signal containing a luminous signal and a color difference signal.

In the above-described image capturing device, image signals of two separate sequences from the first and second solid image capturing devices are alternately selected to produce image signals of one sequence in which the first and second image signals are alternately arranged at predetermined intervals.

### SUMMARY OF THE INVENTION

As described above, in an image capturing device which employs a plurality of solid image capturing elements, distances between the driving circuit and the solid image capturing elements of the respective sequences may differ from one another depending on the structure of a camera body. In such a case, driving the plurality of solid image capturing elements under equal condition is not preferable as such driving cannot sufficiently utilize the characteristics of each solid image capturing element.

Specifically, when the wiring between the driving circuit and a solid image capturing element is longer, impedance of the wire may increase accordingly, resulting in an increase of the rate of loss of the driving capability of a driving clock before the driving clock reaches the solid image capturing element. In order to address this problem, in a case wherein distances between the driving circuit and the respective solid image capturing elements are different from one another, a driving clock for a longer wire should have a higher driving capability than that set for a shorter wire. In addition, a driving clock travelling through a longer wire may be delayed in reaching the destination solid image capturing device by an amount corresponding to the longer length of the wire, which results in inconsistent timing for driving the respective solid image capturing elements. That is, synchronous operation of a plurality of solid image capturing elements is difficult.

Commonly, in order to drive a solid image capturing element, driving condition data is written into a memory means, such as a register, when the power is turned on so that the solid image capturing element is driven based on the condition stored in the memory means. When this method is applied to an image capturing device which employs a plurality of solid image capturing elements, the content of the memory means must be rewritten every time the solid image capturing elements to be driven is switched, in order to set appropriate driving condition for each of the solid image capturing elements. This disadvantageously hampers smooth switching.

In view of the above, the present invention can advantageously provide an image capturing device which employs a plurality of solid image capturing elements and are capable of driving each of the solid image capturing elements under respective optimum conditions while smoothly switching the solid image capturing elements.

In order to provide such an image capturing element, according to the present invention there is provided an image capturing device comprising a first solid image capturing element having a first plurality of light receiving pixels, for storing information charge which is generated in response to a first object image, in the first plurality of light receiving pixels; a second solid image capturing element having a second plurality of light receiving pixels, for storing information charge which is generated in response to a second object image, in the second plurality of light receiving pixels; a driving control circuit for controlling operation of the first and second solid image capturing elements; and a register for storing first and second setting data which respectively designate driving condition for the first and second solid image capturing elements. In this image capturing device, the driving control circuit respectively drives the first and second solid image capturing elements according to the first and second setting data stored in the register.

### BRIEF DESCRIPTION OF THE DRAWINGS

FIG. 1 is a block diagram showing a structure of an embodiment of the present invention;

FIG. 2 is a diagram showing an exemplary circuit structure of a first driving circuit 21a;

FIG. 3 is a diagram showing an exemplary circuit structure of a first delay 29a; and

FIG. 4 is block diagram showing a structure of a conventional image capturing device.

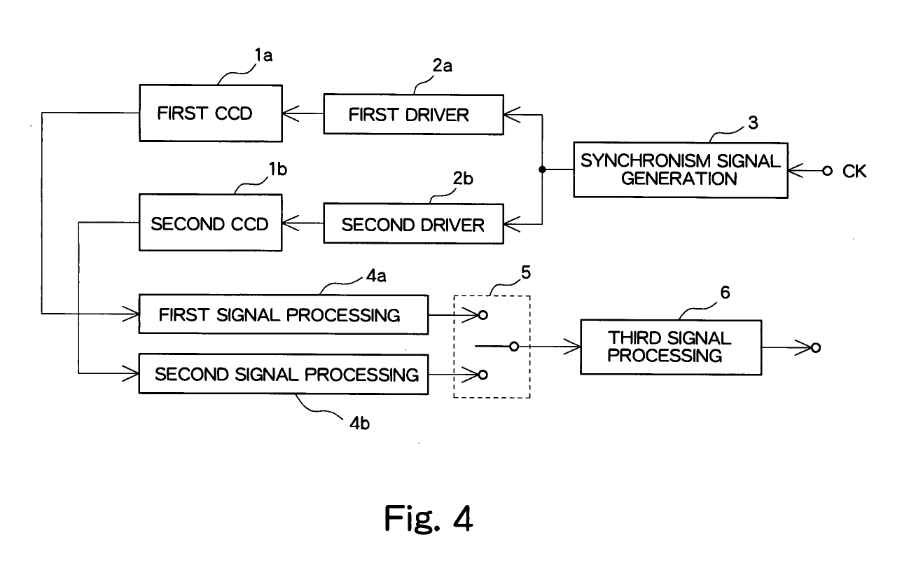

### DESCRIPTION OF THE PREFERRED EMBODIMENTS

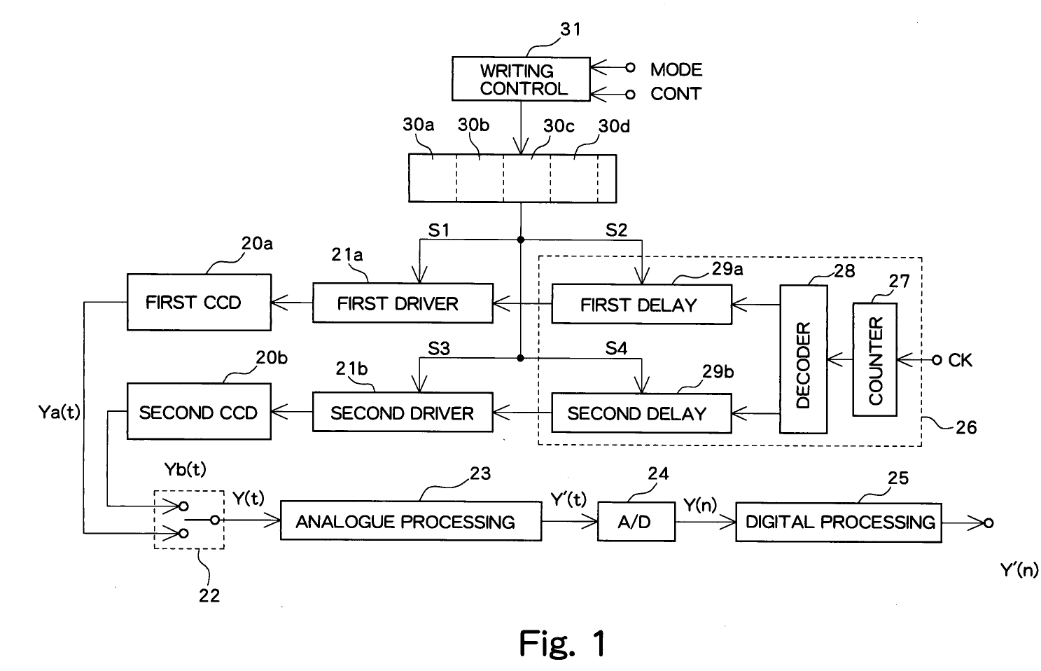

FIG. 1 is a block diagram showing an embodiment of the present invention. The image capturing device shown in FIG. 1 comprises a first solid image capturing device 20a, a first driving circuit 21a, a second solid image capturing device 20b, a second driving circuit 21b, a selection circuit 22, an analogue processing circuit 23, an A/D converter circuit 24, a digital processing circuit 25, a timing control circuit 26, a register 30, and a writing control circuit 31.

The present invention is characterized in that first and second setting data which respectively designate the optimum driving conditions for the first and second solid image capturing elements 20a, 20b is stored in the register 30 so that operations of the first and second solid image capturing elements 20a, 20b are controlled respectively according to the stored first and second setting data.

The first solid image capturing device 20a comprises a plurality of light receiving pixels arranged in a matrix in a light receiving section, and stores first information charge which is generated in response to a first object image received by the light receiving section, in each of the light receiving elements. Such a solid image capturing element may be a frame transfer type for high-speed transfer of information charge for one screen to a storage section, an inter-line type for transfer of information charges stored in a light receiving section to a vertical transfer section arranged between light receiving pixel arrays, a frame inter-line type capable of functions of both the frame transfer and inter-line types, or any other suitable element.

The first driving circuit 21a is provided corresponding to the first solid image capturing device 20a which it drives to extract a first image signal Ya (t). Specifically, the first driving circuit 21a generates a driving clock in response to a timing signal supplied to the timing control circuit 26, and supplies the generated driving clock to the first solid image capturing element 20a, which is driven thereby. For example, in the case where the first solid image capturing device 20a is of a frame-transfer type, a frame transfer clock φf, a vertical transfer clock φv, a horizontal transfer clock φh, and a reset clock φr are created as a driving clock. A frame transfer clock φf is provided for high-speed transfer of information charge for one screen stored in the light receiving section to the storage section. A vertical transfer clock φv is provided for transfer, in units of one line, of information charges for one screen stored in the storage section. A horizontal transfer clock φh is provided for transfer, in units of one pixel, of information charges for one line stored in the horizontal transfer section to an output section. A reset clock φr resets the output section every pixel. With these driving clocks, a first image signal Ya (t) for every pixel can be extracted from the first solid image capturing element 20a. The first driving circuit 21a is constructed so as to allow switching of its driving capabilities and the driving capability to employ is determined according to the first and second setting data stored in the register 30.

Basic structures of the second solid image capturing device 20b and the second driving circuit 21b are similar to those of the first solid image capturing device 20a and the second driving circuit 21b. Specifically, the second solid image capturing device 20b stores information charges which are generated in response to a second object image, in the plurality of light receiving elements, and the second driving circuit 21b drives the second solid image capturing device 20b to extract a second image signal Yb (t).

The selection circuit 22 receives the first and second image signals Ya (t), Yb (t), and selects either one of these image signals Ya (t), Yb (t), in synchronism with an operation timing of the first and second solid image capturing device 20a, 20b, for output as an image signal Y (t). Through the above described processing, an image signal Y (t) of a single sequence comprising the first and second image signals Ya (t), Yb (t) arranged alternately in a predetermined interval is obtained.

The analogue processing circuit 23 applies analogue signal processing including CDS, AGC, and so forth to the image signal Y (t) selected by the selection circuit 22. Specifically, in CDS, an image signal Y (t) which alternately presents reset and signal levels is processed such that a reset level is clamped before a signal level is extracted whereby an image signal with continuous signal levels is created. In AGC, image signals extracted in the CDS for one screen or one vertical scanning period are subjected to integration and the gain is adjusted such that the integrated value remains within a predetermined range.

The A/D converter circuit 24 receives and normalizes an image signal Y′ (t) subjected to analogue signal processing, before converting the standardized image signal Y′ (t) in the form of an analogue signal into a digital signal for output as image data Y (n).

The digital processing circuit 25 performs digital signal processing, including color separation, matrix operation, and so forth, relative to the image data Y (n) output from the A/D converter circuit 24 to thereby create image data Y′ (n) containing a luminous signal and a color difference signal. The digital processing circuit 25 includes an exposure control circuit and a white balance control circuit and performs exposure control to control an exposure state of the first and second solid image capturing devices 20a, 20b, and white balance control to control white balance of the image signal Y (t).

The timing control circuit 26 supplies timing signals to the first and second driving circuits 21a, 21b to determine a timing at which to conduct vertical and horizontal scanning relative to the first and second solid image capturing elements 20a, 20b. Specifically, the timing control circuit 26, which comprises a counter 27, a decoder 28, and first and second delays 29a, 29b, counts a reference clock CK having a constant cycle, using the counter 27 and decodes an output from the counter 27 using the decoder 28 to generate a timing signal. In this operation, it is possible to generate a variety of timing signals by changing a value set to the decoder 28. Then, the timing signal from the decoder 28 is delayed by a predetermined period of time in the first and second delays 29a, 29b, respectively, before outputting to the first and second driving circuits 21a, 21b, respectively.

The timing control circuit 26 may additionally supply a timing signal to circuits other than the first and second driving circuits 21a, 21b, to enable those circuits to operate in synchronism with the operation timing of the first and second solid image capturing devices 20a, 20b.

The register 30 comprises a memory medium which can store data of a predetermined number of bits, and stores first and second setting data which respectively designate driving conditions for the first and second solid image capturing devices 20a, 20b. Of the first and second setting data, the first setting data includes a first setting value S1 for designating driving capability of the first driving circuit 21a, and a third setting value S3 for designating a delay time by which the first delay 29a delays the timing signal, while the second setting data includes a second setting value S2 for designating driving capability of the second driving circuit 21b and a fourth setting value S4 for designating a delay time by which the second delay 29b delays the timing signal.

The register 30 has a memory region which is sectioned into first to fourth blocks 30a to 30d for respectively storing the first and fourth setting values S1 to S4 for separate management. In such a case, it is desirable that addresses in the respective blocks are continuous from one another, such as the first block 30a having addresses 0 to 5, the second block 30b having addresses 5 to 10, and so froth.

The register 30 has another memory region in addition to the first to fourth blocks 30a to 30d for storing a plurality of setting data each corresponding to each of a plurality patterns of image capturing modes and, in response to an externally supplied image capturing mode switching signal MODE, outputs setting data corresponding to an image capturing mode designated by the signal MODE to the decoder 28. It should be noted that the image capturing modes may include a mode for causing either one of the first and second solid image capturing elements 20a, 20b to operate, and another mode for switching, in units of one or more screens, operations of the first and second solid image capturing elements 20a, 20b. With receipt of setting data corresponding to each image capturing mode, the timing control circuit 26 modifies each timing signal according to the designated image capturing mode.

The writing control circuit 31 receives an externally supplied control signal CONT and, in response thereto, writes the first to fourth setting values S1 to S4 into the register 30. Specifically, the control signal CONT, which individually designates the driving conditions for the first and second solid image capturing elements 20a, 20b, is supplied to the writing control circuit 31 simultaneously when the camera is turned on, which then selects a value corresponding to the designated drive condition and writes the selected value into the register 30 as the first to fourth setting values S1 to S4. The writing control circuit 31 additionally receives an externally supplied mode signal MODE and writes setting data corresponding to the image captured mode designated by the signal MODE into the register 30.

As described above, storage of the first and second setting data which respectively designate driving conditions for the first and second solid image capturing elements 20a, 20b enables individual setting of driving conditions for the first and second solid image capturing elements 20a, 20b, thus enabling individual setting of the optimum driving condition relative to each of the first and second solid image capturing elements 20a, 20b. Moreover, collective storage of the first and second setting data into the register 30 enables simultaneous storing of driving conditions for the first and second solid image capturing elements 20b, 20b in the register 30. Thus, the operation conditions for the first and second driving circuits 21a, 21b, and the first and second delays 29a, 29b can be initialized with reference to the content of the register 30. Therefore, rewriting of the content of the register 30 for every switching of the operations of the first and second solid image capturing elements 20a, 20b is unnecessary, which enables smooth switching of the operations of the first and second solid image capturing elements 20a, 20b.

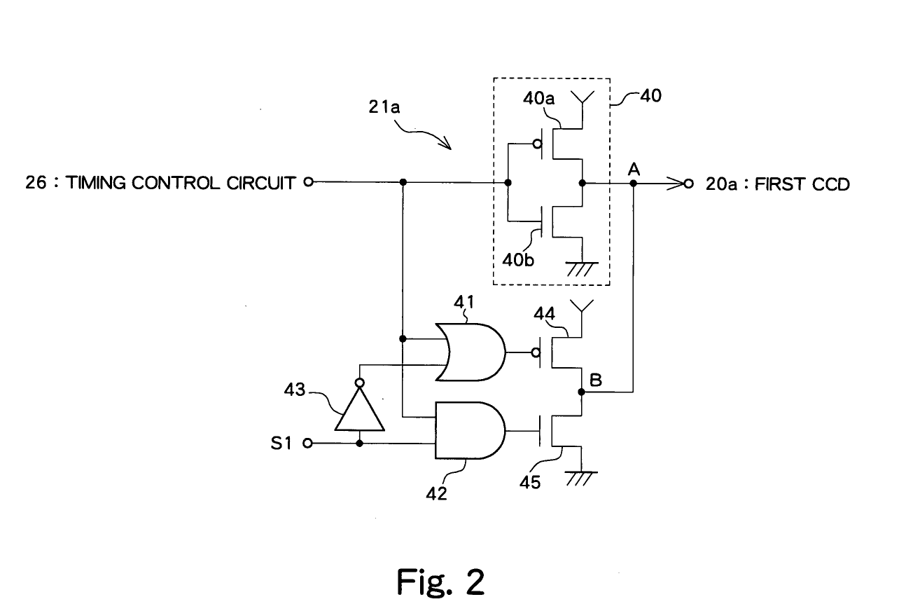

FIG. 2 is a block diagram showing an exemplary circuit structure of the first and second driving circuits 21a, 21b. The first and second driving circuits 21a, 21b have identical circuit structures, and the first driving circuit 21a will herein be referred to as an example.

The first driving circuit 21a comprises a first inverter 40, an OR gate 41, an AND gate 42, a second inverter 43, a first transistor 44, and a second transistor 45. The first inverter 40 inverts a timing signal from the timing control circuit 26 and supplies the resultant signal as a driving clock to the first solid image capturing elements 20a.

The OR gate 41 receives a timing signal at its one input and an output from the second inverter 43 via the other input, and outputs a logical sum of the received inputs. The AND gate 42 receives a timing signal at it one input and a first setting value S1 from the register 30 via the other input, and outputs a logical product of these received inputs.

The second inverter 43 creates an inverted signal of the first setting value S1 to output. The first transistor 44 is a P-channel MOS transistor connected between the power source and a node B and receives, via the gate, a logical sum output from the OR gate 41. The second transistor 45 is an N-channel MOS transistor connected between the grounds and the node B and receives, via the gate, a logical product output from the AND gate 42.

In the following, an example of operation of the circuit shown in FIG. 2 will be described.

The first inverter 40 inverts a timing signal and supplies the resulting inverted timing signal as a driving clock to the first solid image capturing device 20a. In the above, the driving clock acquires predetermined driving capability from a current route from the power supply via the first solid image capturing element 40a to the node A and also from a route from the node A via the second solid image capturing element 40b to the ground.

When the first setting value S1 is “0” (L level) in the above, the AND gate 42 produces an output at an L level and the OR gate 41, which receives a signal at an H level resulting from the first setting value S1 inverted by the second inverter 43, produces an output at an H level. This causes both the first and second transistors 44, 45 to be turned off, leaving the node B in a high impedance state. As a result, the current route from the node B to the node A becomes ineffective. Consequently, a driving clock with driving capability acquired from the first inverter 40 is supplied to the first solid image capturing device 20a.

When the first setting value S1 is “1” (H level), on the other hand, the AND gate 42 receives a signal at an H level at its one input and the OR gate 41 receives a signal at an L level at its one input. Thus, the AND gate 42 and the OR gate 41 operate according to the level of the timing signal.

Specifically, when the timing signal is at an H level, both the AND gate 42 and the OR gate 41 output signals at an H level, in response to which the second transistor 45 is turned on whereby the current route from the node B to node A is caused to be effective. The signal at an H level additionally causes the third transistor 40b of the first inverter 40 to be turned on, which then outputs a signal at an L level. Consequently, the driving capability achieved from the current route from the grounds, the node B, to the node A is added to the driving clock having driving capability originated from the first inverter 40, so that the resultant driving clock having the enhanced driving capability is output from the first driving circuit 21a.

When the timing signal is at an L level, similarly, the first transistor 44 is turned on in synchronism with the operation of the first inverter 40, so that a driving clock with enhanced driving capacity is output.

The above described circuit structure enables switching of the driving capabilities of the first driving circuit 21a, and which driving capability is to be employed is determined according to the first setting value S1. This arrangement enables selection of an optimum level driving capability in view of the length of the wire between the first solid image capturing device 20a and the first driving circuit 21a out of those at a plurality of levels and, moreover, the selection is easily achievable by changing the first setting value S1.

The first driving circuit 21a includes as many above-described circuit structures as the types of its outputs. As these circuit structures commonly receive a first setting value S1, the driving capability of the entire first driving circuit 21a can be instantly changed by changing the first setting value S1.

It should be noted that, although two-stage switching of driving capabilities is described in the above, the present invention is not limited to such an arrangement. The driving capabilities can, for example, be switched at a larger number of stages through three or more structures connected in parallel to the first inverter 40, each including the OR gate 41, the AND gate 42, the second inverter 43, and the first and second transistors 44, 45.

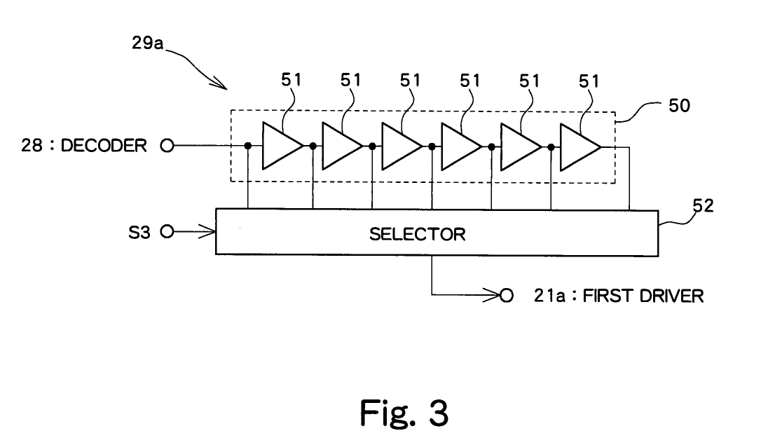

FIG. 3 is a diagram showing an exemplary circuit structure of the first and second delays 29a, 29b. The first and second delays 29a, 29b have identical circuit structures, and the first delay 29a will be referred to as an example here.

The first delay 29a comprises a delay circuit 50 and a selector 52. The delay circuit 50 includes a plurality of serially connected delay elements 51 for each delaying a received signal by a predetermined amount of time, whereby an input timing signal from the decoder 28 is sequentially delayed by the respective delay elements 51. The selector 52 is connected in parallel to the delay circuit 50 to receive an output from each of the delay elements 51 of the delay circuit 50 and, in response to the third setting value S3, selects any one of the outputs from the plurality of delay elements 51 for output as a delay timing signal to the first driving circuit 21a. Therefore, in an example wherein the delay circuit 50 supplies seven outputs to the selector 52, as shown in FIG. 3, three bit data is created as a third setting value S3 so that any one of the outputs from the delay elements 51 may be selected with reference to the three bit data.

The timing control circuit 29 includes as many above-described circuit structures as types of driving clocks output from the decoder 28, and these circuits commonly receive a third setting value S3.

As described above, the period of time during which the first delay 29a delays a received signal is switchable, and a delay time to employ is selectable based on the first setting value S3. This arrangement enables precise setting of a delay time appropriate in view of the length of the wire between the first solid image capturing device 20a and the first driving circuit 21a, so that the operations of the first and second solid image capturing elements 20a, 20b can easily be synchronized with each other.

According to the present invention, it is possible to drive respective solid image capturing elements of an image capturing device which employs a plurality of solid image capturing elements, under respective optimum conditions while smoothly switching operations of the respective solid image capturing elements.

What is claimed is:

1. An image capturing device comprising:
a first solid image capturing element having a first plurality of light receiving pixels, for storing information charge which is generated in response to a first object image, in the first plurality of light receiving pixels;
a second solid image capturing element having a second plurality of light receiving pixels, for storing information charge which is generated in response to a second object image, in the second plurality of light receiving pixels;
a driving control circuit for controlling operation of the first and second solid image capturing elements; and
a register for storing first and second setting data which respectively designate driving condition for the first and second solid image capturing elements,
wherein
the driving control circuit drives the first and second solid image capturing elements respectively according to the first and second setting data stored in the register.

2. The image capturing device according to claim 1, wherein the register comprises a memory region sectioned into a plurality of blocks for respectively storing the first and second setting data.

3. The image capturing device according to claim 1, wherein the driving control circuit comprises a timing control circuit for determining timing for conducting vertical and horizontal scanning relative to the first and second solid image capturing elements and generating a first timing signal and a second timing signal, a first driving circuit for driving the first solid image capturing element in response to the first timing signal, and a second driving circuit for driving the second solid image capturing element in response to the second timing signal, and the first driving circuit and second driving circuit are constructed such that driving capabilities thereof are respectively switchable and driving capabilities thereof to be employed are determined according to the first and second setting data, respectively.

4. The image capturing device according to claim 3, wherein the timing control circuit comprises a counter for counting a predetermined reference clock, a decoder for decoding an output from the counter to thereby create the first timing signal and the second timing signal, and a delay circuit for delaying the first timing signal and the second timing signal by a period of time which is changeable, wherein the delay circuit determines the period of time by which to delay, according to the first and second setting data.
